(19) United States
(12) Patent Application Publication
(10) Pub. No.: US 2024/0141208 A1
(43) Pub. Date: May 2, 2024

(54) TAPE, WIRE HARNESS, AND METHOD FOR PRODUCING WIRE HARNESS

(71) Applicant: YAZAKI CORPORATION, Tokyo (JP)

(72) Inventors: Ryo Nagashima, Makinohara-shi (JP); Harutake Satoh, Makinohara-shi (JP)

(21) Appl. No.: 18/490,754

(22) Filed: Oct. 20, 2023

(30) Foreign Application Priority Data
Oct. 31, 2022 (JP) 2022-174986

(51) Int. Cl. C09J 7/24; C09J 7/38; H01B 7/00; H01B 13/012

(52) U.S. Cl. CPC C09J 7/245; C09J 7/38; H01B 7/0045; H01B 13/01263; C09J 2301/302; C09J 2301/41; C09J 2400/20

(57) ABSTRACT

A tape includes a tape base material obtained by kneading, into a PVC resin added with a plasticizer, a stabilizer and a coloring agent, a filler in a particle state such as calcium for improving tearability. A color of the tape base material is set to a receding color other than black by an action of the coloring agent. The tape end portion of the PVC tape is whitened by tearing.

### CROSS-REFERENCE TO RELATED APPLICATIONS

This application is based on and claims priority under 35 USC 119 from Japanese Patent Application No. 2022-174986 filed on Oct. 31, 2022, the contents of which are incorporated herein by reference.

### TECHNICAL FIELD

The present invention relates to a tape that can be torn off with fingers in a tape winding operation, a wire harness around which the tape is wound, and a method for producing a wire harness.

### BACKGROUND ART

In recent years, a PVC tape has been widely used for bundling a plurality of electric wires, protecting electric wires, electrically insulating electric wires, or the like, due to good operability and durability thereof. As this PVC tape, a non-adhesive tape and an adhesive tape are included in the related art. This type of PVC tape is generally made of a polyvinyl chloride resin (PVC) to which a plasticizer and a stabilizer are added.

In a case that this PVC tape is used as a winding tool, when cutting the tape at a winding end in a tape winding operation, it is sometimes to perform cutting with scissors or a cutter, but during an operation with one hand, it is often impossible to use scissors or a cutter, and the operation is often done by tearing off with fingers. Therefore, a tape base material in the PVC tape in the related art is produced by kneading a filler into a polyvinyl chloride resin (PVC) added with a plasticizer and a stabilizer to enable easily tearing off with fingers (see, for example, Patent Literature 1).

As this filler, calcium carbonate and calcined clay are mainly used. In this way, the filler to be kneaded for improving tearability (tear property) is a white powder, and is dispersed and scattered in the PVC plasticized by the plasticizer in a particle state without being melted.

### CITATION LIST

### Patent Literature

Patent Literature 1: JPH06-62427U

### SUMMARY OF INVENTION

When using the tape in the related art, it is often difficult to find an end portion of the tape once a color of the tape base material is black. For example, when an end portion of a black tape wound in a roll shape overlaps a body of the black tape without misalignment, it is difficult to find the end portion (starting end) of the tape in the next use of the tape because the colors are the same. In addition, when it is necessary to remove the wound tape in order to modify a tape winding portion of a wire harness or to add a circuit of the wire harness, it is also difficult to find the end portion of the tape with the same color.

The present invention has been made in view of the above circumstances, and an object thereof is to provide a tape made of PVC, which makes it easy to find an end portion of the tape that has been torn off by hand, a wire harness around which the tape is wound, and a method for producing the wire harness.

In order to achieve the above object, a tape, a wire harness, and a method for producing a wire harness according to the present invention are characterized as follows.

A tape of the present disclosure includes a tape base material formed of a PVC resin, and an adhesive layer. A plasticizer, a stabilizer, and a coloring agent are added to the PVC resin, and the coloring agent is set to a color that causes a color of the tape base material to be a receding color excluding black.

A wire harness of the present disclosure includes a wire harness body, and the above tape which is attached to the wire harness body and whitened by tearing off an end portion thereof.

A method for producing a wire harness of the present disclosure includes pulling out, from a roll portion, the tape wound in a roll shape, attaching the tape to a wire harness body, and tearing off the tape from the roll portion.

According to the present invention, when the tape is torn off by hand, the end portion of the tape that has been torn off is white and conspicuous due to a whitening phenomenon caused by a tensile stress. Therefore, it is possible to easily find the end portion of the tape when pulling out the tape from a tape roll and when peeling off the tape from a state where the tape is wound around an object.

The present invention is briefly described above. Further, details of the present invention can be clarified by reading modes for carrying out the invention (hereinafter, referred to as “embodiments”) described below with reference to the accompanying drawings.

### BRIEF DESCRIPTION OF DRAWINGS

FIG. 1 is a side view and a front view showing a tape roll obtained by winding, in a roll shape, a tape according to an embodiment of the present invention;

FIG. 2 is a side view of a wire harness formed by winding the tape according to the embodiment around a bundle of a plurality of electric wires (wire harness body); and

FIG. 3 is a photograph showing that a torn end portion of the tape according to the embodiment is whitened and conspicuous.

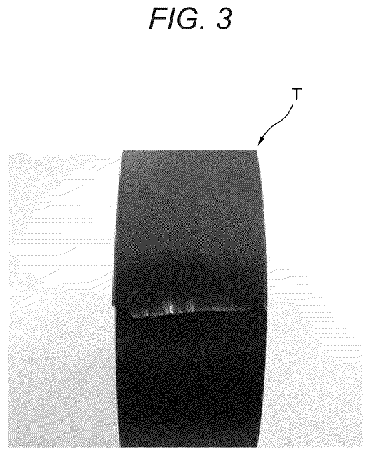

### DESCRIPTION OF EMBODIMENTS

A specific embodiment of the present invention will be described below with reference to the drawings.

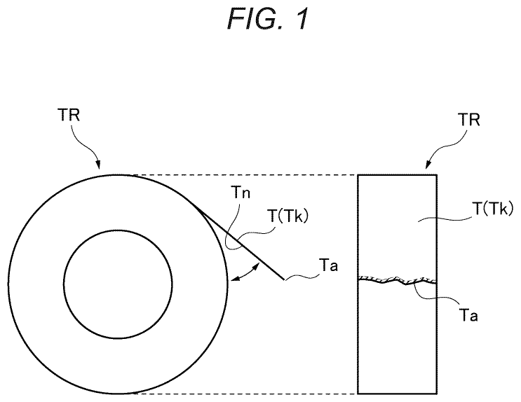

FIG. 1 is a side view and a front view showing a tape roll obtained by winding, in a roll shape, a tape according to an embodiment of the present invention.

As shown in FIG. 1, a PVC (polyvinyl chloride resin) tape T according to the present embodiment is formed as an adhesive tape in which an adhesive layer Tn is formed on one surface of a tape base material Tk, and is provided in a form of a tape roll TR wound in a roll shape with the adhesive layer Tn facing downward. This PVC tape T is used as a winding tape for bundling a plurality of electric wires, protecting the electric wires, and electrically insulating the electric wires.

The tape base material Tk of the PVC tape T is obtained by kneading, into a PVC resin added with a plasticizer, a stabilizer and a coloring agent, a filler in a particle state such as calcium for improving tearability. A color of the tape base material Tk is set to a receding color other than black by an action of the coloring agent.

The PVC tape T has a thickness of 0.24 mm or less and an elongation rate of 200% or more in a longitudinal direction. The PVC tape T more preferably has an elongation rate of 300% or more. Due to such properties, when the PVC tape T is attached to or wound around an object such as a wire harness, the object can be protected from surrounding obstacles.

As the coloring agent, receding colors (also called contraction color, a color that visually appears to be further away than it actually is) other than black, such as dark green, blue, or brown coloring agents are used. As the filler, calcium carbonate, calcined clay, and the like are used, but the filler is not limited to these.

When the PVC tape T according to the embodiment is torn off by hand, a whitening phenomenon occurs at a torn end portion. The reason why the whitening phenomenon occurs is that the filler scattered in the particle state (white particles) in the tape base material Tk is exposed on a tape surface due to a tensile stress when the PVC tape T is torn off by hand. The scattered filler particles expose the tape surface as irregularities, reducing a gloss of the tape surface and making the tape surface appear white. At this time, when the color of the tape base material Tk is set to a receding color, whitening becomes conspicuous. Therefore, as shown in a right part (front view) in FIG. 1, in the tape roll TR obtained by winding the PVC tape T in a roll shape, a tape end portion Ta can be easily identified. Therefore, an operator can easily pull out the PVC tape T from the tape roll TR and wind or attach the PVC tape T around or to an object such as a wire harness.

In a case that the color of the tape base material Tk is black, even when the PVC tape T stretches while being torn off, the color of the tape base material Tk is darker than the color of the scattered filler, and even when the gloss of the tape surface is reduced, the whitening is not sufficient, and the tape end portion Ta cannot be easily identified. However, when the color of the tape base material Tk is a receding color (for example, dark green, blue, or brown) other than black, the whitening becomes conspicuous.

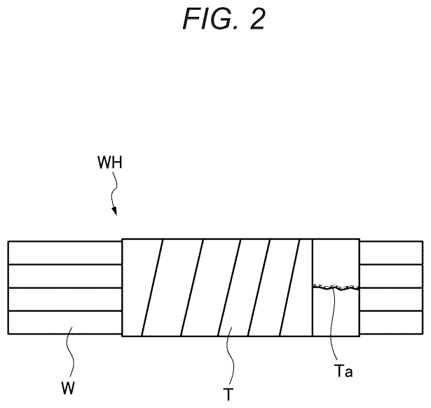

FIG. 2 is a side view of a wire harness formed by winding the PVC tape T according to the embodiment around a bundle of a plurality of electric wires (wire harness body).

For a wire harness WH shown in FIG. 2, tape winding is completed by winding the PVC tape T shown in FIG. 1 around a bundle of a plurality of electric wires (wire harness body W) and tearing off the PVC tape T at the end portion Ta as a winding end. In this wire harness WH, the winding end (tape end portion Ta) of the PVC tape T wound around the wire harness body W is whitened by tearing.

In this case, when the color of the tape base material Tk is set to a receding color, the whitening of the tape end portion Ta also becomes conspicuous. Therefore, even when peeling off the PVC tape T from the wire harness WH in response to a certain request, the operator can easily find the end portion of the wound tape T and immediately peel the tape T off. Of course, the tape end portion Ta in the tape roll TR is also whitened and easily identified. Therefore, when tape winding is performed on another position of the wire harness WH, or when tape winding is performed on the wire harness WH next time, the operator can also easily pull out the adhesive tape from the tape roll TR.

Therefore, in a case of performing tape winding on the wire harness WH, either a tape in the related art that does not cause noticeable whitening or the PVC tape T according to the present embodiment may be used at a position where an automatic tape winding machine is used. Production efficiency of the wire harness WH can be improved by using the PVC tape T according to the present embodiment at the position where the operator performs the tape winding. Note that the PVC tape T according to the present embodiment is not limited to being wound around the wire harness WH. Even when attaching the PVC tape T in a straight line, or when sticking two PVC tapes T in a straight line, the tape end portion Ta can also be easily identified.

Note that the present invention is not limited to the above embodiment, and modifications, improvements, and the like can be made as appropriate. In addition, materials, shapes, sizes, numbers, arrangement positions, and the like of components in the above embodiment are freely selected and are not limited as long as the present invention can be implemented.

Here, features of the tape, the wire harness, the wire harness around which the tape is wound, and the method for producing the wire harness according to the above embodiment of the present invention will be briefly summarized and listed in the following [1] to [4]. [1] A tape (T) including:
a tape base material (Tk) formed of a PVC resin; and
an adhesive layer (Tn), in which
a plasticizer, a stabilizer, and a coloring agent are added to the PVC resin, and
the coloring agent is set to a color that causes a color of the tape base material (Tk) to be a receding color excluding black.

When the tape (T) having the above configuration [1] is torn off by hand, a whitening phenomenon occurs at a torn end portion (tape end portion (Ta)). The reason why the whitening phenomenon occurs is that the filler scattered in a particle state (white particles) in the tape base material (Tk) is exposed on a tape surface due to a tensile stress when the tape (T) is torn off by hand. The scattered filler particles expose the tape surface as irregularities, reducing a gloss of the tape surface and making the tape surface appear white. At this time, when the color of the tape base material (Tk) is set to a receding color, whitening becomes conspicuous. Therefore, in a tape roll (TR) obtained by winding the tape (T) in a roll shape, the tape end portion (Ta) can be easily identified. In addition, when the tape end portion (Ta) is white and conspicuous, it is possible to easily find the tape end portion (Ta) even when removing the tape (T) from a state where the tape (T) is wound around the object.

[2] A wire harness (WH) including:
a wire harness body (W); and
the tape (T) according to the above [1], which is attached to the wire harness body (W) and whitened by tearing off an end portion thereof.

According to the above configuration [2], the tape end portion (Ta) appears white, so that an operator can easily find the tape end portion (Ta) being attached.

[3] The wire harness (WH) according to the above [2], in which
the tape (T) is attached to a position where an object to be attached or detached from the wire harness body (W) is fixed to the wire harness body (W).

According to the above configuration [3], when removing the object from the wire harness body (W), the operator can easily recognize the end portion of the tape (T) for attaching the object to the wire harness body (W), so that an operation of peeling off the tape (T) can be started immediately.

[4] A method for producing a wire harness (WH) including:
pulling out, from a roll portion, the tape (T) according to the above [1] and wound in a roll shape, attaching the tape (T) to a wire harness body (W), and tearing off the tape (T) from the roll portion.

According to the above configuration [4], when the tape (T) is used as a tape that needs to be peeled off after being attached to the wire harness body (W) by winding or the like, the operator can easily find the tape end portion (Ta) attached to the wire harness body (W) and immediately peel the tape (T) off.

What is claimed is:

1. A tape comprising:
a tape base material formed of a PVC resin; and
an adhesive layer, wherein
a plasticizer, a stabilizer, and a coloring agent are added to the PVC resin, and
the coloring agent is set to a color that causes a color of the tape base material to be a receding color excluding black.

2. A wire harness comprising:
a wire harness body; and
the tape according to claim 1, which is attached to the wire harness body and whitened by tearing off an end portion thereof.

3. The wire harness according to claim 2, wherein
the tape is attached to a position where an object to be attached or detached from the wire harness body is fixed to the wire harness body.

4. A method for producing a wire harness comprising:
pulling out, from a roll portion, the tape according to claim 1 and wound in a roll shape;
attaching the tape to a wire harness body; and
tearing off the tape from the roll portion.
